(19) United States
(12) Patent Application Publication
(10) Pub. No.: US 2002/0085958 A1
(43) Pub. Date: Jul. 4, 2002

(54) Apparatus for pretreating a sample containing an analyte

(76) Inventors: Thomas A. Nemcek, Crystal Lake, IL (US); John Brian Barclay II, Pleasant Prairie, WI (US); Jovo Dragicevic, Milwaukee, WI (US); Paul Leonard Eck, Deerfield, IL (US); David Henry Gement, Union Grove, WI (US); Seymour Greenfield, Skokie, IL (US); Michelle Petra Haddon, Libertyville, IL (US); Michael James Nolan, Lake Forest, IL (US); Steven Louis Strang, Wadsworth, IL (US); Stephen Melamed, Chicago, IL (US); Vincent Shine, Chicago, IL (US); Peter Langmar, Chicago, IL (US); Laura A. Ferrario, Chicago, IL (US); Luc Heiligenstein, Chicago, IL (US)

Correspondence Address: Steven F. Weinstock, Abbott Laboratories, CHAD 377/ AP6D, 100 Abbott Park, Abbott Park, IL, 60064-6050, US

(21) Appl. No.: 09/903,062

(22) Filed: Jul. 11, 2001

Related U.S. Application Data
(62) Division of application No. 09/317,412, filed on May 24, 1999.

(51) Int. Cl. G01N 31/22; B01L 3/14

(52) U.S. Cl. 422/102; 422/58; 422/100; 422/103

(57) ABSTRACT

The present invention relates to a container having internal projections capable of exerting compressive, frictional, or other forces on a sample-collecting device and sample before detecting an analyte in the sample. The invention can be used whenever detecting an analyte in a sample is improved or made possible by first changing the physical or chemical properties of the sample or analyte in a pretreatment step.

This is a divisional of U.S. patent application Ser. No. 09/317,412, filed May 24, 1999.

### FIELD OF THE INVENTION

The present invention relates to an apparatus for detecting an analyte in a sample, and further relates to a pretreatment cup from which the sample can be introduced into a testing device.

### BACKGROUND

Scientists, doctors, and others use a variety of procedures to detect a substance of interest—an analyte—in a sample. Frequently analyte detection is made possible or is improved by first changing physical or chemical properties of the sample, the analyte, or both. In other words, pretreating the sample may be desirable or necessary before detecting the analyte.

Doctors often depend on accurate and timely detection of certain analytes to treat and manage physical disorders. For example, certain species of the bacteria streptococcus cause scarlet fever and tonsillitis. If a doctor can quickly and accurately detect the presence of these bacteria, then he or she can quickly and successfully treat the infected patient.

Immunological assays are valuable in detecting various analytes, including analytes derived from streptococcus. Immunological assays frequently involve specific binding reactions between antibodies and antigens. For example, certain immunological testing devices for Group A streptococcus work by attaching a visible label to antigens from streptococcus—the streptococcus antigen is the analyte—and capturing the antigen/label with an

Detection of Group A Streptococcus

| Solid phase below | | | Visually detectable |
|---|---|---|---|
| window on test device | Antigen | Label | antigen |
| 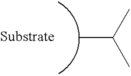 | 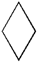 | 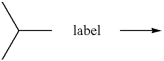 | 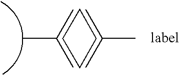 |
| Antibody | Antigen from | Antibody with | |
| | Group A streptococcus | visual label | |

antibody combination below a transparent window:

These testing devices are generally designed so that the captured antigen/label combinations, if present, form a line or other symbol beneath the window. A doctor or other health-care professional simply looks at the window on the device to determine if a patient is infected with Group A streptococcus.

Group A streptococcus antigens are not available for detection, however, without pretreating a sample obtained from a patient. Different tests for Group A streptococcus employ different approaches to pretreatment. In one approach, a test operator pretreats a sample in a cup separate from the immunological testing device. Typically the operator first obtains secretions from a patient's throat using a sample-collecting device, such as a swab. The operator then places the swab in a cup and adds acid. The acid breaks down the cell walls of Group A streptococcus present in the sample, releasing antigens. After adding other reagents, if necessary, the operator transfers some or all of the solution from the cup into an opening on the immunological testing device. The operator then reads the testing device and determines if Group A streptococcus antigens are present.

The operator can control pretreatment time because the swab is pretreated in a cup separate from the testing device. The immunological test does not begin until the operator transfers solution from the cup to the testing device. Also, the manufacturer of the testing device can optimize and suggest a pretreatment time that releases sufficient analyte for detection while keeping the test time acceptable to doctors and their patients. Furthermore, if the cup is flexible, the operator can pinch the outside of the cup to squeeze the swab inside the cup. The operator can also turn the swab while pinching the cup to scrape the swab surface against the cup interior. These compressive, frictional, or other forces help mix or combine any pretreating reagents and the sample, and also help squeeze liquid from the swab. When an operator is pretreating a sample believed to contain Group A streptococcus, these forces increase the amount of antigen—if present—available for subsequent detection.

There are disadvantages to this approach. The aforementioned manipulations increase variability in the amount of antigen released for subsequent detection. Each operator likely exerts different amounts of force on the swab, and may compress the swab a different number of times during pretreatment. These manipulations increase the risk of spilling and contamination—a risk already present because pretreated sample is transferred from the cup to a testing device. Also, because the sample cup is not connected to the testing device, a test operator may mismatch test results with the wrong patient.

Another approach avoids some of these disadvantages. In the second approach, a chamber integral to the immunological testing device receives a swab bearing a sample. To release Group A streptococcus antigens, acid is added to the chamber holding the swab and sample. Because the pretreated sample is not transferred from a cup to a testing device, the risk of spilling the sample is reduced. Also, the possibility of mismatching test results with the wrong patient is minimized. But the immunological test begins as soon as acid is added to the chamber. Therefore the operator cannot easily control pretreatment time or manipulate the device, swab, and sample during a selected pretreatment time.

For the foregoing reasons, there is a need for a pretreatment method and device that allows the operator to control pretreatment time while at the same time reducing the chance of spilling and contamination, mismatching test results with the wrong sample source, and/or variability associated with manipulating a sample cup during a selected pretreatment time.

### SUMMARY

The present invention is based on the discovery that a sample containing an analyte may be pretreated in a container or compartment that is, or will be, connected to a testing device, but initially is not in fluid communication with the testing elements of the testing device. After the desired pretreatment time has expired, the test operator takes some action to render the container or compartment in fluid connection with the testing elements of the testing device. Another aspect of the invention is that the container or compartment may incorporate projections extending into the interior of the container or compartment. The projections facilitate pretreating a sample on a sample-collecting device prior to detecting an analyte in the sample. An operator positions and moves the sample-collecting device, such as a swab, relative to the container or compartment so that these projections exert frictional, compressive, or other forces on the sample-collecting device and sample. These forces help mix any pretreating reagents and the sample, and help squeeze liquid from the sample-collecting device prior to detecting the analyte.

Accordingly, in accordance with a principal feature of the present invention, an apparatus includes a testing device which is operative to detect and provide an output indicative of an analyte in a test sample. The apparatus further includes a container having an opening configured to receive the test sample. A support structure on the testing device is configured to engage and support the container in a predetermined pretreatment orientation. The support structure can further engage and support the container for movement relative to the support structure from the pretreatment orientation to a predetermined testing orientation. Moreover, the container and the testing device are configured to block the testing device from detecting the analyte in the sample when the container is in the pretreatment orientation, and to enable the testing device to detect the analyte in response to movement of the container from the pretreatment orientation to the testing orientation.

In the preferred embodiments of the invention, the containers comprise elongated cup-shaped structures with longitudinal axes. Each container is moved from the pretreatment orientation to the testing orientation by rotating the cup about the axis. In several of the preferred embodiments, the cups are also shifted along their axes.

In accordance with a more specific feature of the invention, the container and the testing device are configured to initiate a flow of the sample from the interior compartment of the container to the testing device upon movement of the container from the pretreatment orientation to the testing orientation. In the preferred embodiments of this feature of the invention, the flow of the sample can be initiated by rupturing the container or by opening a valve. The flow of the sample can alternatively be initiated by moving a semipermeable membrane portion of the container into fluid flow contact with a corresponding membrane portion of the testing device.

In accordance with another principal feature of the invention, a container has an interior compartment with sufficient volume to contain a sample including an analyte, a reagent added to pretreat the sample, and a portion of a sample- collecting device inserted into the compartment. Projections extend from the interior surface of the container into the compartment. The projections are configured to exert a force on the sample collecting device so as to remove the sample from the sample collecting device upon movement of the sample collecting device forcefully against the projections. In a preferred embodiment of this feature of the invention, the projections are radially extending fins.

### BRIEF DESCRIPTION OF THE DRAWINGS

FIGS. 1, 2, and 3A-3F illustrate a first embodiment of the invention.

FIGS. 4, 5, and 6A-6E illustrate a second embodiment of the invention.

FIGS. 7A-7F and 8 illustrate a third embodiment of the invention.

FIGS. 9A-9F illustrate parts that are configured for use in alternative embodiments of the invention.

FIGS. 10 and 11A-11D illustrate a fourth embodiment of the invention.

FIGS. 12A and 12B illustrate a top view and a side view of one embodiment of a container having internal projections in accordance with the invention.

### DETAILED DESCRIPTION

### I. Introduction

The present invention is particularly useful for pretreating a sample prior to detecting an analyte. For example, the invention provides for pretreating biological samples before immunologically detecting the presence of a pathogenic bacterium, including certain species of streptococcus. But the invention may be used for a variety of other analytes that may need some type of pretreatment, including but not limited to, analytes from influenza, RSV, and chlamydia.

The invention can be used to change the physical or chemical properties of a sample or analyte before detecting the analyte. For example, a pretreatment step may be used to alter the pH of the sample to ensure that specific binding reactions necessary for immunological detection occur. Or sample pretreatment may be necessary to lyse bacterium cell walls so that an analyte, such as Group A streptococcus antigens, are available for detection. Alternatively, the invention can be used to disperse, mix, or combine a sample with a liquid having a lower viscosity than the sample. The dispersion or mixture, having a lower viscosity than the sample, flows more readily through the testing elements of a testing device. One embodiment of an immunological test for Group A streptococcus, described above, requires that the pretreated sample flow through a matrix incorporating the compounds used to detect streptococcus antigens. First, the pretreated sample flows through a region in the matrix where streptococcus antigens combine with labeled antibodies. The antigen/labeled antibody combination then flows to a region in the matrix where the combination is captured by antibodies bound to the matrix below a transparent window. For such devices, liquid reagents not only serve to release streptococcus antigens, they also facilitate flow through the testing device by lowering viscosity. In some instances, a sample may contain an analyte already available for detection, and any reagents added to pretreat the sample may serve only to change the physical properties of the sample, such as viscosity.

Also, elements of the method used to detect the analyte may be incorporated into sample pretreatment. In a test for Group A streptococcus, for example, a reagent that labels the antigen for subsequent detection might be added during the selected pretreatment time rather than in the testing device.

Samples pretreated using the present invention may be derived from any desired source, including blood, saliva, ocular lens fluid, cerebral fluid, sweat, urine, milk, ascites fluid, mucous, synovial fluid, peritoneal fluid, amniotic fluid, or the like. The fluid can be processed prior to use, such as preparing plasma from blood, diluting viscous fluids, or the like; methods of treatment can also involve separation, filtration, distillation, concentration, inactivation of interfering components, and the addition of reagents. Besides physiological fluids, other liquid samples such as water, food products, and the like can be used. In addition, a solid can be used once it is modified to form a liquid medium.

A number of embodiments of containers of the present invention are described below. These containers may be made from polymeric materials, including polyethylene, polypropylene, polyvinyl chloride, polystyrene, acrylic polymers, polyurethane, and the like, or blends of these polymers. Injection molding, compression molding, blow molding, rotational molding, hand-machine operations, and other techniques may be used to build or form containers of the present invention. Non-polymeric materials also can be used to build or form the containers. A container of the present invention may be formed or built from materials that are the same as or different from materials used to form or build the housing of a testing device with which the container is used.

In addition to the embodiments described below, containers of the present invention can be cylindrical, columnar, conical, columelliform, tubular, barrel-shaped, drum-shaped, funnel-shaped, or have some other geometry. The container must permit insertion of a sample-collecting device into the interior compartment of the container. The container must also allow the addition of any reagents needed to pretreat a sample on a sample-collecting device. The height of the container is selected so that the container can hold any reagents added to pretreat a sample on a sample-collecting device.

### II. Immunological Assays

The invention may be used with many categories of assays, including immunological assays, of which the Group A streptococcus assay described above is one example. Immunological assays depend on specific binding reactions between immunoglobulins (antibodies, or Ab) and materials presenting specific antigenic determinants (antigens, or Ag). Antibodies bind selectively with ligand materials presenting the antigen for which they are specifically reactive and are capable of distinguishing the ligand from other materials having similar characteristics.

### A. Types of Immunological Assays

Schematic representations of examples of several types of immunological assays for antigen and antibody analytes are set forth as follows. One skilled in the art, however, can conceive of other types of assays, including assays for analytes other than antigens or antibodies, to which the present inventive concepts can be applied.

1. Direct Assays

A. Antigen (Ag) Assay

| | | | Labelled |
|---|---|---|---|
| | Solid Phase | Analyte | anti-analyte |
| micro- particle | 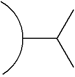 | 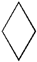 | 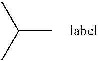 |
| | Ab | Ag | Ab₂ |

Ab may or may not be the same as Ab₂, and may be a monoclonal antibody or a polyclonal antibody.

Examples of antigen-analytes that may be detected using the methods and devices of the invention using the foregoing reaction scheme include Group A streptococcus.

(THIS SHEET NEEDS TO BE REPLACED BY COPY OF PAGE AS INDICATED AS SUCH LOCATED IN THE FILE)

B. Antibody (Ab) Assay

| | | | Labelled |
|---|---|---|---|
| (ii) | Solid Phase | Analyte | anti-analyte |
| micro- particle | 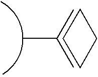 | 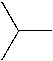 | 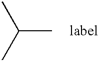 |
| | Ab | Ag | Ab |

2. Indirect Assays

Antigen Assay

| | | | | Labelled |
|---|---|---|---|---|
| | Solid Phase | Analyte | Ab | anti-Ab |
| micro- particle | 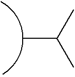 | 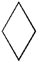 | 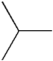 | 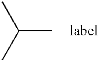 |
| | Ab | Ag | Ab | Ab |

This is a group of assays where the label is not directed against the analyte. In this embodiment, anti-Ab, may be directed against Ab, in general, or may be directed against one or more functional groups incorporated into Ab.

It is also desirable, in some cases, to capture the analyte directly on the solid phase, as follows:

| | | | | Labelled |
|---|---|---|---|---|
| | Solid Phase | Analyte | Ab | anti-Ab |
| micro- particle | 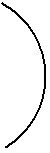 | 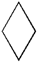 | 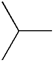 | 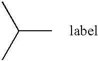 |
| | Ag | Ab | Ab | |

3. Competitive Assays

| | Solid Phase | |
|---|---|---|
| micro- particle | 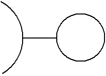 | 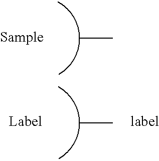 |
| | Ab | |

In assay scheme 3, both the sample and the label are directed against the antigen on the solid phase. The amount of label reflects the amount of antibody in the sample.

### B. Description of Immunological Assays

The following pages provide additional detail regarding immunological assays with which the concepts of the present invention can be applied.

### 1. Definitions

“Specific binding member” means a member of a specific binding pair, i.e., two different molecules wherein one of the molecules through chemical or physical means specifically binds to the second molecule. In addition to antigen and antibody specific binding pairs, other specific binding pairs include as examples, without limitation, biotin and avidin, carbohydrates and lectins, complementary nucleotide sequences such as the probe and capture nucleic acids used in hybridization reactions with a target nucleic acid sequence as the analyte, complementary peptide sequences, effector or receptor molecules, enzyme cofactors and enzymes, enzyme inhibitors and enzymes, enzyme substrates and enzymes, a peptide sequence and an antibody specific for the sequence or the entire protein, and the like. Furthermore, specific binding pairs can include members that are analogs of the original specific binding member, for example an analyte-analog. If the specific binding member is an immunoreactant it can be, for example, an antibody, antigen, hapten, or complex thereof, and if an antibody is used, it can be a monoclonal or polyclonal antibody, a recombinant protein or antibody, a mixture(s) or fragment(s) thereof, as well as a mixture of an antibody and other specific binding members. The details of the preparation of such antibodies and their suitability for use as specific binding members are well known to those skilled in the art.

When an immunoreactive specific binding member is attached to the chromatographic material, the device is referred to as an “immunochromatograph,” and the corresponding method of analysis is referred to as “immunochromatography.” Immunochromatography encompasses immunoassay techniques including sandwich and competitive immunoassay techniques.

“Analyte” means the compound or composition to be detected or measured in the test sample. In a binding assay, the analyte will have at least one epitope or binding site for which there exists a naturally occurring, complementary specific binding member or for which a specific binding member can be prepared. “Analyte” also includes any antigenic substances, haptens, antibodies, and combinations thereof. The analyte of interest in an assay can be, for example, a protein, a peptide, an amino acid, a nucleic acid, a hormone, a steroid, a vitamin, a pathogenic microorganism for which polyclonal and/or monoclonal antibodies can be produced, a natural or synthetic chemical substance, a contaminant, a drug including those administered for therapeutic purposes as well as those administered for illicit purposes, and metabolites of or antibodies to any of the above substances.

“Analyte-analog” means a substance which cross-reacts with an analyte-specific binding member, although it may do so to a greater or a lesser extent than does the analyte itself. The analyte-analog can include a modified analyte as well as a fragmented or synthetic portion of the analyte molecule so long as the analyte-analog has at least one epitopic site in common with the analyte of interest.

“Label” means any substance which is attached to a specific binding member and which is capable of producing a signal that is detectable by visual or instrumental means. Various suitable labels for use in the present invention can include chromogens, catalysts, fluorescent compounds, chemiluminescent compounds, radioactive labels, direct visual labels including colloidal metallic and non-metallic particles, dye particles, enzymes or substrates, or organic polymers, liposomes, or other vesicles containing signal producing substances, and the like.

In an alternative signal producing system, the label can be a fluorescent compound where no enzymatic manipulation of the label is required to produce a detectable signal. Fluorescent molecules such as fluorescein, phycobiliprotein, rhodamine, and their derivatives and analogs are suitable for use as labels in this reaction.

A visually detectable, colored particle can be used as the label component of the indicator reagent, thereby providing for a direct colored readout of the presence or concentration of the analyte in the sample without the need for further signal producing reagents. Materials for use as the colored particles are colloidal metals, such as gold, and dye particles, as well as non-metallic colloids, such as colloidal selenium particles. Organic polymer latex particles may also be used as labels.

“Signal producing component” means any substance capable of reacting with another assay reagent or the analyte to produce a signal that indicates the presence of the analyte and that is detectable by visual or instrumental means. “Signal production system” means the group of assay reagents that are needed to produce the desired reaction product or signal. For example, one or more signal producing components can be used to react with a label and generate the detectable signal, i.e., when the label is an enzyme, amplification of the detectable signal is obtained by reacting the enzyme with one or more substrates or additional enzymes to produce a detectable reaction product.

“Ancillary specific binding member” means any member of a specific binding pair which is used in the assay in addition to the specific binding members of the capture reagent and the indicator reagent and which becomes a part of the final binding complex. One or more ancillary specific binding members can be used in an assay. For example, an ancillary specific binding member can be capable of binding the analyte, as well as a second specific binding member to which the analyte itself could not attach.

### 2. Reagents and Materials

### a. Binding Assay Reagents

Binding assays involve the specific binding of the analyte and/or indicator reagent (comprising a label attached to a specific binding member) to a capture reagent (comprising a second specific binding member) which immobilizes the analyte and/or indicator reagent on a chromatographic material or which at least slows the migration of the analyte or indicator reagent through the chromatographic material.

The label, as described above, enables the indicator reagent to produce a detectable signal that is related, either directly or inversely depending upon the type of immunoassay, to the amount of analyte in the pretreated sample. The specific binding member component of the indicator reagent enables the indirect binding of the label to the analyte, to an ancillary specific binding member of the label to the analyte, to an ancillary specific binding member, or to the capture reagent. The selection of a particular label is not critical, but the label will be capable of generating a detectable signal either by itself, such as a visually detectable signal generated by colored organic polymer latex particles, or in conjunction with one or more additional signal producing components, such as an enzyme/substrate signal producing system. A variety of different indicator reagents can be formed by varying either the label or the specific binding member. It will be appreciated by one skilled in the art that the choice involves consideration of the analyte to be detected and the desired means of detection.

The capture reagent, in a binding assay, is used to facilitate the observation of the detectable signal by substantially separating the analyte and/or the indicator reagent from other assay reagents and the remaining components of the pretreated sample. The capture reagent is a specific binding member, such as those described above. In a binding assay, the capture reagent is immobilized on the chromatographic material to form a “capture situs,” i.e., that region of the chromatographic material having one or more capture reagents non-diffusively attached thereto.

### b. Application Pad

An application pad, if present, is in fluid flow contact with one end of the chromatographic material, referred to as the proximal end, such that the pretreated sample can pass or migrate from the application pad to the chromatographic material; fluid flow contact can include physical contact of the application pad to the chromatographic material as well as the separation of the pad from the chromatographic strip by an intervening space or additional material which still allows fluid flow between the pad and the strip. Substantially all of the application pad can overlap the chromatographic material to enable the pretreated sample to pass through substantially any part of the application pad to the proximal end of the strip of chromatographic material. The application pad can be any material which can transfer the pretreated sample to the chromatographic material and which can absorb a volume of pretreated sample that is equal to or greater than the total volume capacity of the chromatographic material.

Materials preferred for use in the application pad include nitrocellulose, porous polyethylene frit or pads and glass fiber filter paper. The material must also be chosen for its compatibility with the analyte and assay reagents.

In addition, the application pad may contain one or more assay reagents either diffusively or non-diffusively attached thereto. Reagents which can be contained in the application pad include, but are not limited to, indicator reagents, ancillary specific binding members, and any signal producing system components needed to produce a detectable signal. As discussed below, one or more of these reagents may also be incorporated into the chromatographic material.

If present, the application pad receives the pretreated sample, and the wetting of the application pad by the sample will perform at least two functions. First, it will dissolve or reconstitute a predetermined amount of any reagent contained by the pad. Secondly, it will initiate the transfer of both the test sample and any freshly dissolved reagent to the chromatographic material. In some instances, the application pad serves a third function as both an initial mixing site and a reaction site for the pretreated sample and any reagent present in the pad. The application pad may also serve as a filter for particulate material in the sample.

Gelatin may be used to encompass all or part of the application pad. Typically, such encapsulation is produced by overcoating the application pad with fish gelatin. The effect of this overcoating is to increase the stability of any reagent contained by the application pad. Transport of pretreated sample to the overcoated application pad causes the gelatin to dissolve and thereby enables the dissolution of any reagent present in the pad. A reagent-containing application pad may be dried or lyophilized to increase the shelf-life of the device.

An immunochromatographic device can also include a filtration means. The filtration means can be a separate material placed above or before the application pad or between the application pad and the chromatographic material, or the material of the application pad itself can be chosen for its filtration capabilities. The filtration means can include any filter or trapping device used to remove particles above a certain size from the pretreated sample. For example, the filter means can be used to remove red blood cells from a sample of whole blood, such that plasma is the fluid received by the application pad and transferred to the chromatographic material.

Porous material placed between the application pad, if present, and the chromatographic material, or overlaying the application pad, again if present, can serve as a means to control the rate of flow of the pretreated sample to the chromatographic material, or to prevent unreacted assay reagents from passing to the chromatographic material.

When small quantities of non-aqueous or viscous test samples are applied to the application pad, it may be necessary to employ a wicking solution, preferably a buffered solution, to carry the reagent(s) and pretreated sample through the application pad, if present, and through the chromatographic material. When an aqueous sample is used, a wicking solution generally is not necessary but can be used to improve flow characteristics or adjust the pH of the pretreated sample. Often a pH is selected to maintain a significant level of binding affinity between the specific binding members in a binding assay. When the label component of the indicator reagent is an enzyme, however, the pH also must be selected to maintain significant enzyme activity for color development in enzymatic signal production systems. Illustrative buffers include phosphate, carbonate, barbitl, diethylamine, ris, and the like.

### c. Chromatographic Material

The chromatographic material of an immunochromatographic assay device can be any suitably absorbent, porous, or capillary possessing material through which a solution containing the analyte can be transported by a wicking action. Natural, synthetic, or naturally occurring materials that are synthetically modified, can be used as the chromatographic material including, but not limited to: cellulose materials such as paper, cellulose, and cellulose derivatives such as cellulose acetate and nitrocellulose; fiberglass; cloth, both naturally occurring (e.g., cotton) and synthetic (e.g., nylon); porous gels such as silica gel, agarose, dextran, and gelatin; porous fibrous matrixes; starch based materials, such as Sephadex® brand cross-linked dextran chains; ceramic materials; films of polyvinyl chloride and combinations of polyvinyl chloride-silica; and the like. The chromatographic material should not interfere with the production of a detectable signal. The chromatographic material should have a reasonable inherent strength, or strength can be provided by means of a supplemental support.

The particular dimensions of the chromatographic material will be a matter of convenience, depending upon the size of the pretreated sample involved, the assay protocol, the means for detecting and measuring the signal, and the like. For example, the dimensions may be chosen to regulate the rate of fluid migration as well as the amount of pretreated sample to be imbibed by the chromatographic material.

A symbol or line indicative of the analyte can be formed by directly or indirectly attaching the analyte's capture reagent to the chromatographic material. Direct attachment methods include adsorption, absorption and covalent binding such as by use of (i) a cyanogen halide, e.g., cyanogen bromide or (ii) by use of glutaraldehyde. Depending on the assay, it may be preferred, however, to retain or immobilize the desired reagent on the chromatographic material indirectly through the use of insoluble microparticles to which the reagent has been attached. The means of attaching a reagent to the microparticles encompasses both covalent and non-covalent means, that is adhered, absorbed, or adsorbed. By “retained and immobilized” is meant that the particles, once on the chromatographic material, are not capable of substantial movement to positions elsewhere within the material. The particles can be selected by one skilled in the art from any suitable type of particulate material composed of polystyrene, polymethylacrylate, polyacrylamide, polypropylene, latex, polytetrafluoroethylene, polyacrylonitrile, polycarbonate, glass or similar materials. The size of the particles is not critical, although generally it is preferred that the average diameter of the particles be smaller than the average pore or capillary size of the chromatographic material.

The capture reagent(s), signal producing component(s) or reagent coated microparticles can be deposited singly or in various combinations on or in the chromatographic material in a variety of configurations to produce different detection or measurement formats. For example, a reagent can be deposited at a discrete situs having an area substantially smaller than that of the entire chromatographic material.

An immunochromatographic assay can incorporate a reagent, at the downstream or distal end of the chromatographic material, which indicates the completion of a binding assay (i.e., an end-of-assay indicator that changes color upon contact with a pretreated sample solution).

Reagents can be added directly to a compartment or container of the present invention during performance of the assay. Alternatively, all necessary assay reagents are incorporated into the chromatographic material and, if present, the application pad.

### III. Embodiments of the Invention

### A. Shear-pin Embodiment

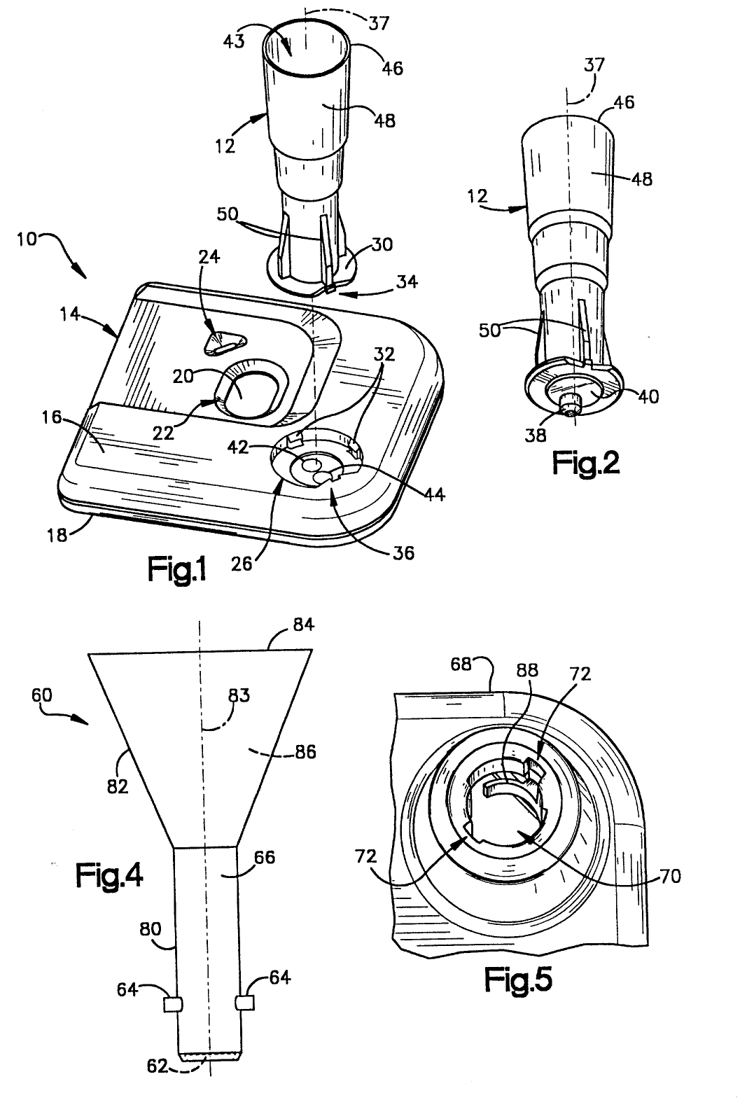

As shown in FIG. 1, an apparatus comprising a first embodiment of the present invention includes a testing device 10 and a generally cylindrical container 12. The testing device 10 is a particular type of device which is commonly referred to as a test pack. The testing device 10 thus has a generally rectangular housing 14 including upper and lower plastic housing parts 16 and 18. A test element 20 is visible through a pair of output windows 22 and 24 in the upper housing part 16. The test element 20 in this embodiment is an assay element that responds to a test sample by providing a first visible output signal in the first window 22 to indicate the presence or absence of a specified amount in analyte in the test sample, and further by providing a second visible output signal in the second window 24 to indicate when the assay is complete. Such a test element may comprise any suitable structure in any suitable configuration known in the art.

The upper housing part 16 defines a receiving well 26 in which the housing 14 receives and supports the container 12 in accordance with the present invention. The container 12 includes a disc 30 that snaps under a plurality of overhangs 32 defined by the upper housing part 16 at the periphery of the receiving well 26. The disc 30 has a key feature 34 that aligns with a mating key feature 36 in the upper housing part 16. The mating key features 34 and 36 ensure proper orientation of the container 12 and the housing 14 when the container 12 is first inserted into the receiving well 26. The container 12 is thus snapped into interlocked engagement with the housing 14 in a predetermined pretreatment orientation relative to the housing 14. The mating key features 34 and 36 are configured so that the container 12 may be rotated about its longitudinal central axis 37 relative to the housing 14 when the disc 30 is received under the overhangs 32.

As shown in FIG. 2, the container 12 includes a shear pin 38 that projects longitudinally from the bottom wall 40 of the container 12 at a location laterally offset from the axis 37. The shear pin 38 is received in a pin capture hole 42 at the bottom of the receiving well 26 when the container 12 is moved to the pretreatment orientation in the foregoing manner. To render the interior compartment 43 of the container 12 in fluid communication with the testing device 10, an operator rotates the container 12 so that the shear pin 38 is sheared off to form a hole at the bottom of the container 12. The newly formed hole at the bottom of the container 12 allows a pretreated sample in the container 12 to drain from the container 12 through a drain hole 44 at the bottom of the receiving well 26 upon rotation of the container 12 fully from the pretreatment orientation to a predetermined testing orientation which is offset from the pretreatment orientation 180 degrees about the axis 37.

The upper end 46 of the container 12 is open to permit insertion of a sample-collecting device and the introduction of a reagent into the container compartment 43. The peripheral wall 48 of the container 12 is preferably formed of flexible plastic and most preferably has a thickness from about 0.75 mm to about 1.75 mm.

The container 12 preferably has a plurality of reinforcing ribs 50. The reinforcing ribs 50 are generally polygonal in shape, and are molded or built so that they join with the disk 30 and the peripheral wall 48 of the container 12.

FIGS. 3A-3F illustrate one possible sequence of steps for pretreating a sample using the embodiment of the invention shown in FIG. 1. In step 3A, the key feature 34 on the container 12 is aligned with the mating key feature 36 on the housing 14 of the testing device to ensure proper placement of the container 12 in the pretreatment orientation. The disk 30 at the bottom of the container 12 is then snapped under the overhangs 32 at the periphery of the receiving well 26, with the shear pin 38 at the bottom of the container 12 being inserted into the pin-capture hole 42 in the housing 14. The container compartment 43 is not yet in fluid communication with the testing device 10, permitting the operator to pretreat a sample for a desired pretreatment time.

In step 3B, a sample on a sample-collecting device 54—in this case a swab—is placed inside the container compartment 43.

In steps 3C and 3D, reagents are added to pretreat the sample inside the compartment 43. While FIGS. 3C and 3D illustrate sequentially adding two reagents to the sample, one or more than two reagents may be necessary for pretreatment. Multiple reagents may be added sequentially or simultaneously.

After the second reagent is added in step 3D, the test operator waits for the desired pretreatment time to expire. But pretreatment time may begin to elapse after addition of the first reagent, or at some other step in the procedure. The sample-collecting device 54 is then withdrawn, as depicted in step 3E. If the upper portion of the container 12 is sufficiently flexible, the test operator may squeeze the swab by pinching the peripheral wall 48 of the container 12 against the swab 54. By squeezing the swab 54 with the peripheral wall 48, the test operator increases the amount of pretreated sample available for subsequent detection of an analyte in the sample.

In step 3F, the test operator rotates the container 12, shearing off the pin 38 and creating an opening in the bottom wall 40 (FIG. 2) of the container 12. The liquid contents then drain through the opening and the drain hole 44 (FIG. 1) so that the analyte, if present, is detected by the particular test element 20 contained in the testing device 10.

The invention encompasses variations of the method described above. Rather than attach a container of the present invention to a test-device housing before pretreating the sample, a test operator can pretreat the sample in the container and then attach the container to the test-device housing. Furthermore, an operator can add one or more reagents to a container of the present invention before inserting a sample-collecting device (and sample) into the container. Finally, the invention encompasses reagents added during sample pretreatment to label the analyte of interest for subsequent detection using a testing device.

### B. Semi-permeable Membrane Embodiment

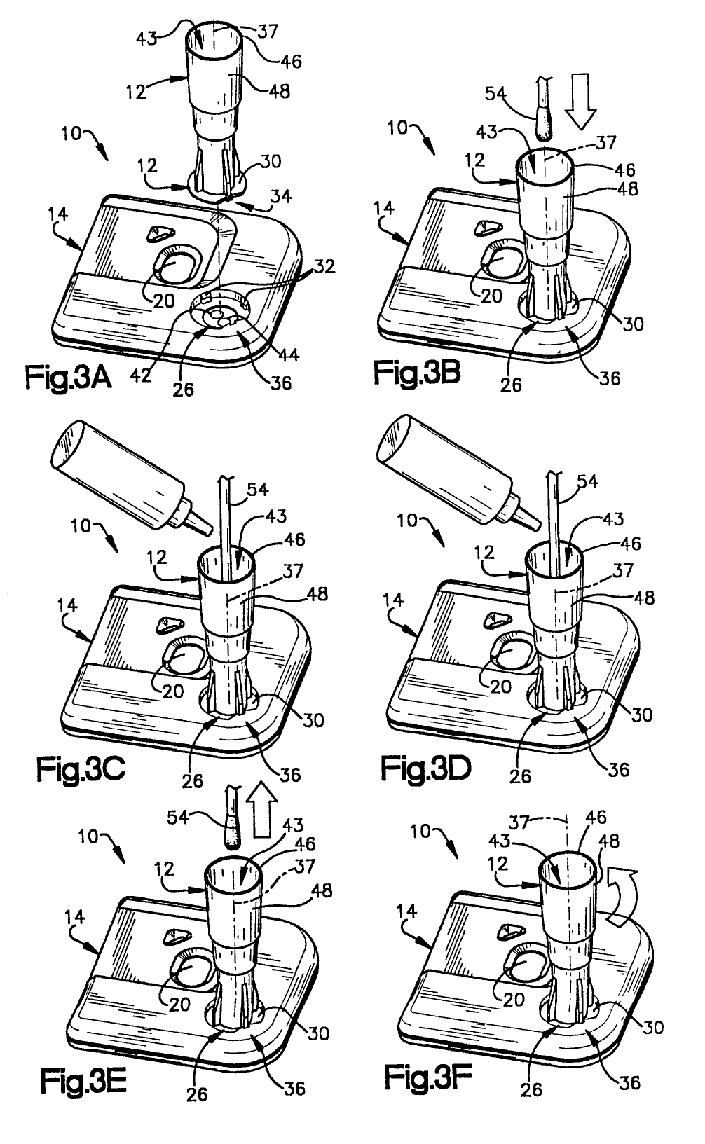

A second embodiment of the present invention is shown in FIGS. 4, 5, and 6A-6E. This container 60 is molded or built to incorporate a semi-permeable membrane 62 as part or all of the bottom wall of the container 60. Such a membrane may be formed of any suitable material known in the art. A plurality of projections 64 extend outwardly from the peripheral wall 66 of the container 60. These projections 64 serve to ensure proper alignment of the container and a corresponding test pack housing 68 when the container 60 is first inserted downward into a receiving well 70 in the housing 68. The projections 64, in conjunction with channels 72 incorporated into the housing 68 at the periphery of the receiving well 70, also serve to guide subsequent rotational and downward movements that bring the semi-permeable membrane 62 into contact with a pad 74 (shown schematically in FIG. 6A) inside the test pack housing 68. When the container 60 is first inserted downward into the receiving well 70, there is an air gap between the semi-permeable membrane 62 and the pad 74. The pretreated sample is placed in fluid communication with the testing elements 74 and 75 in the housing 68 only when the container 60 is rotated and pushed downward so that the semi-permeable membrane contacts the pad 74 inside the housing 68.

More specifically, the container depicted in FIG. 4 has a lower, cylindrical portion 80 and an upper, conical portion 82, each of which is centered on a longitudinal axis 83. The top 84 of the container 60 is open to permit insertion of a sample-collecting device and the introduction of a reagent. The shape of the upper portion 82 of the container 60 is not restricted to a conical shape. But the shape of the upper portion 82 should be designed so that the interior volume of the container 60 exceeds the volume of the sample; any reagents added to pretreat the sample; and that portion of the sample-collecting device that becomes submersed in reagents added to sample. The peripheral wall 86 of the upper portion 82 is preferably flexible, as described above with reference to the peripheral wall 48 of the container 12.

FIGS. 6A-6E illustrate one possible sequence of steps for pretreating a sample using the embodiment depicted in FIGS. 4 and 5. In step 6A, the projections 64 on the container 60 are aligned with the channels 72 at the top of the receiving well 70. The container 60 is then pushed axially downward to a predetermined pretreatment orientation in which the projections 64 rest on arcuate ledges 88 (one of which is visible in FIG. 5) in the receiving well 70. The interior compartment 89 of the container 60 is not yet in fluid connection with the testing elements 74 and 75 in the housing 68, permitting the operator to pretreat a sample for a desired pretreatment time.

In step 6B, a sample on a sample-collecting device 90—in this case a swab—is placed inside the compartment 89.

In step 6C, a reagent is added to pretreat the sample. While FIG. 6C illustrates adding one reagent to the sample, more than one reagent may be necessary for pretreatment.

The test operator allows the desired pretreatment time to expire. The container 60 is than rotated about the axis 83 (step 6D) so that the projections 64 are moved off the ends of the arcuate ledges 88 (FIG. 5), and is pushed further axially downward (step 6E) from the pretreatment orientation to a predetermined testing orientation in which the semi-permeable membrane 62 contacts the pad 74 inside the housing 68. The liquid contents then flow from the compartment 89 through the semi-permeable membrane 62, and any analyte present in the liquid is detected by the testing elements 74 and 75 in the housing 68.

### C. Pierceable Membrane Embodiment

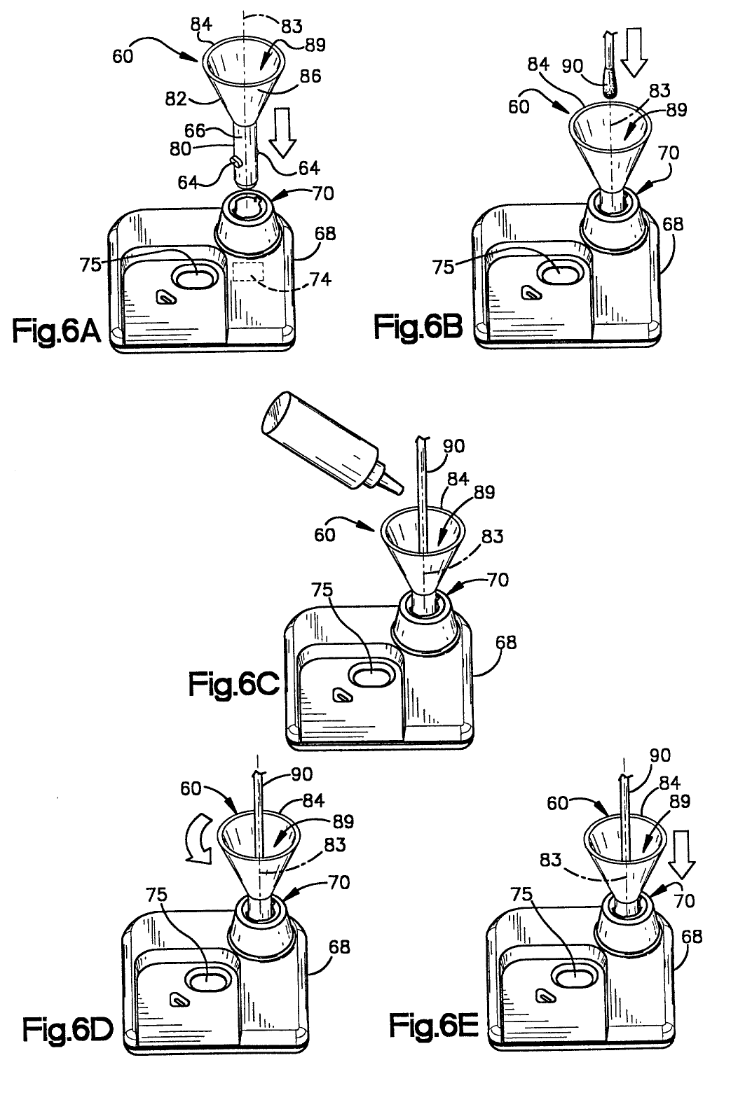

A third embodiment of the present invention is depicted in FIGS. 7A-7F. This container 100 is molded or built to incorporate a pierceable membrane 102 as part or all of the bottom wall of the container 100. A plurality of pins 104 extend outwardly from the peripheral wall 106 of the container 100. These pins 104 serve to ensure proper alignment of the container 100 and a corresponding test pack housing 110 when the container 100 is first inserted downward into a receiving well 112 in the housing 110. The pins 104, in conjunction with channels 114 in the receiving well 112, also serve to guide subsequent rotational and downward movements that cause the membrane 102 to be pierced by a cannula at the bottom of the well 112.

More specifically, the container 100 is generally cylindrical, with the cross-sectional area of the container 100 increasing in step-wise fashion from the bottom 102 of the container to the top 116. A container of the present invention may alternatively have a constant diameter. The top 116 of the container 100 is open to permit insertion of a sample-collecting device and the introduction of a reagent. The peripheral wall 106 may have a non-uniform thickness, but also is preferred to be flexible, as described above.

Some or all of the pierceable bottom wall 102 preferably has a thickness less than ½ the thickness of the peripheral wall 106, more preferably having a thickness less than ¼ the thickness of the peripheral wall 106, and most preferably having a thickness less than 1/10 the thickness of the peripheral wall 106, but greater than 0.01 mm. The pierceable bottom wall 102 and the peripheral wall 106 could be portion of a one-piece wall structure, or could be separate pieces that are joined together. Such separate pieces could be formed the same or differing materials.

FIGS. 7A-7F illustrate one possible sequence of steps for pretreating a sample using the container 100. In step 7A, the projections 104 on the container 100 are aligned with the channels 114 at the top of the receiving well 112. The container 100 is then pushed axially downward to a predetermined pretreatment orientation. The interior compartment 120 of the container 100 is not yet in fluid connection with the testing element 122 in the housing 110, permitting the operator to pretreat a sample for a desired pretreatment time.

In step 7B, a sample on a sample-collecting device 124—in this case a swab—is placed in the compartment 120.

In step 7C, a reagent is added to pretreat the sample. While FIG. 7C illustrates adding one reagent to the sample, more than one reagent may be necessary for pretreatment.

The test operator allows the desired pretreatment time to expire, and removes the swab 124 (step 7D). Then the container 100 is rotated about its axis 125 (step 7E) and is pushed further axially downward (step 7F) to a predetermined testing orientation so that the cannula in the well 112 pierces the membrane 102. The liquid contents then flow through newly opened hole, and any analyte present in the liquid is detected by the testing element 122 of the testing device.

FIG. 8 is a partial view of a bottom wall 126 of the receiving well 112, showing the cannula 128 beside a drain hole 129 leading to the test element 122.

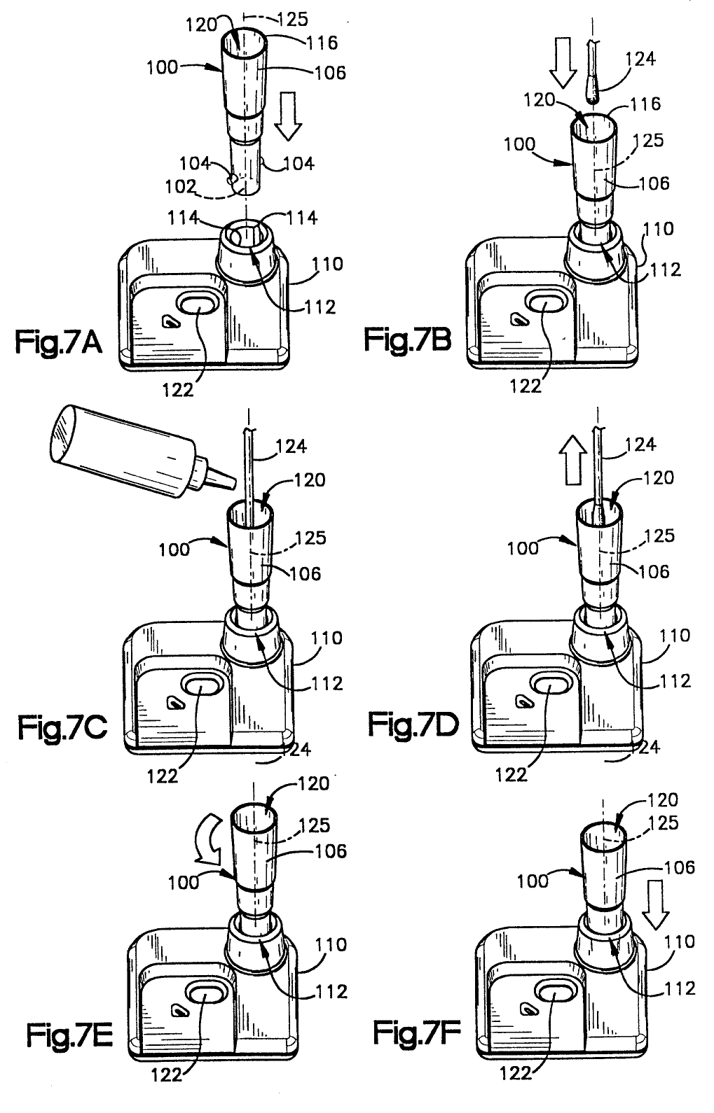

FIGS. 9A-9F show receiving well structures 130-135 including piercing cannulas 140-145, respectively, and further including channels 146 like the channels 114. Each of these channels 146 receives a corresponding projection 104 on the container 100, and has first and second rest surfaces 147 and 148 defining the predetermined pretreatment orientation and the predetermined testing orientation, respectively. Moreover, each of these channels 146 is configured to constrain the container 100 to move axially upward from the pretreatment orientation before moving axially downward into the testing orientation. This helps to ensure that the container 100 is not moved to the testing orientation inadvertently. These are shown as examples of receiving well structures that can be used as parts of a test pack housing in accordance with the present invention.

### D. Valve Embodiment

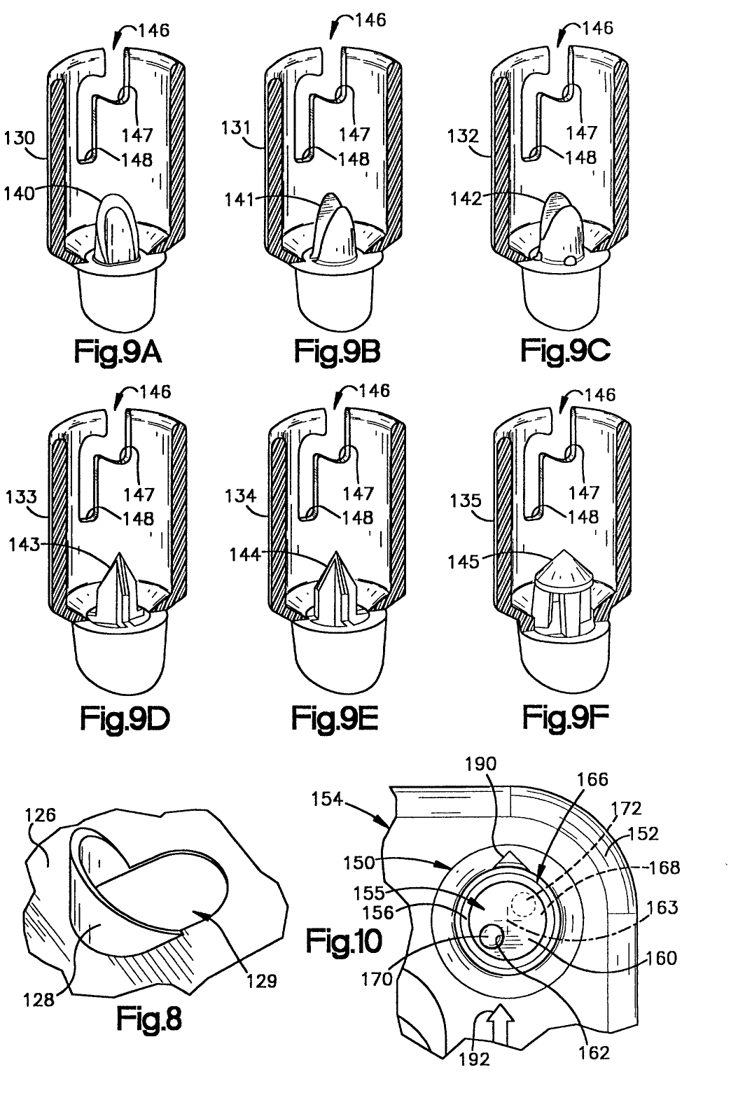

A fourth embodiment of the invention includes a container 150 which is connected to the housing 152 of a test pack 154. This container 150 also is rendered in fluid connection with a testing element in the test pack 154 in accordance with the present invention, as shown in FIGS. 10 and 11A-11D.

The container 150 is generally cylindrical. The top 156 of the container 150 is open to permit insertion of a sample-collecting device and the introduction of a reagent. The bottom wall 160 of the container 150 incorporates a first circular drain hole 162 that is laterally offset from the longitudinal central axis 163 of the container 150.

The test pack housing 152 has a well 166 in which the container 150 is connected to the housing 152 and supported for rotation about the axis 163 relative to the housing 152. The well 166 has a bottom wall 168 that incorporates both a valve seat 170 and a second circular drain hole 172. Both the valve seat 170 and second drain hole 172 are laterally offset from the axis 163, with the second drain hole 172 preferably being laterally opposite the valve seat 170. As shown in FIG. 10, the container 150 has a predetermined pretreatment orientation in which the valve seat 170 is received closely within the first drain hole 162 in the bottom wall 160 of the container 150. The first drain hole 162 is then closed by the valve seat 170.

FIGS. 11A-11D illustrate one possible sequence of steps for pretreating a sample using this embodiment. In step 11A, a sample on a sample-collecting device 180—in this case a swab—is placed in the compartment 155.

In step 11B, a reagent is added to pretreat the sample. While FIG. 11B illustrates adding one reagent to the sample, more than one reagent may be necessary for pretreatment.

The test operator allows the desired pretreatment time to expire. Then the sample-collecting device 180 is removed (step 11C) and the container 150 is rotated about the axis 163 relative to the housing 152 from the pretreatment orientation to a predetermined testing orientation in which the drain hole 162 in the bottom wall 160 of the container 150 is positioned over the drain hole 172 in the bottom wall 168 of the receiving well 166. The pretreated sample then flows through the second drain hole 172 and contacts the testing element 182 of the testing device 154. The testing orientation is preferably identified by alignment indicators 190 and 192 on the container 150 and the housing 152, respectively. Similar visible orientation indicators can be used on any of the other embodiments of the invention.

### E. Embodiments having Internal Projections

The embodiments described above, as well as other embodiments of the present invention, may incorporate projections extending into the interior of the container compartment. The container and the projections may be made from the same or different materials. Like a container of the present invention, the projections may be made from polymeric materials, including polyethylene, polypropylene, polyvinyl chloride, polystyrene, acrylic polymers, polyurethane, and the like, or blends of these polymers. Injection molding, compression molding, blow molding, rotational molding, hand-machine operations, and other techniques may be used to build or form a container, with or without projections. Non-polymeric materials can also be used to build or form the container or projections. The container and projections may be of unitary construction, or may be built or formed from separate pieces. The only constraint in selecting materials for construction is that the projections must be capable of exerting compressive, frictional, or other forces on a sample-collecting device and sample.

The number, location, and geometry of the projections may be selected from a wide variety of possible combinations. For example, the projections may take the shape of cones, cylinders, slabs, or other geometries. The projections may have a smooth or rough surface. The edges of the projections may be straight or incorporate a pattern (e.g., a serrated or scalloped edge). Again the only constraint is that the projections must be capable of exerting compressive, frictional, or other forces on the sample-collecting device and sample. Preferably the projections are located so that they extend above and below any liquid level formed when a liquid reagent is added to pretreat the sample.

The height of the container is selected so that the container can hold any reagents added to pretreat a sample on a sample-collecting device. Preferably the height of the container is selected so that the sample-collecting device and sample can be placed in contact with the projections above or below the liquid level of an added reagent.

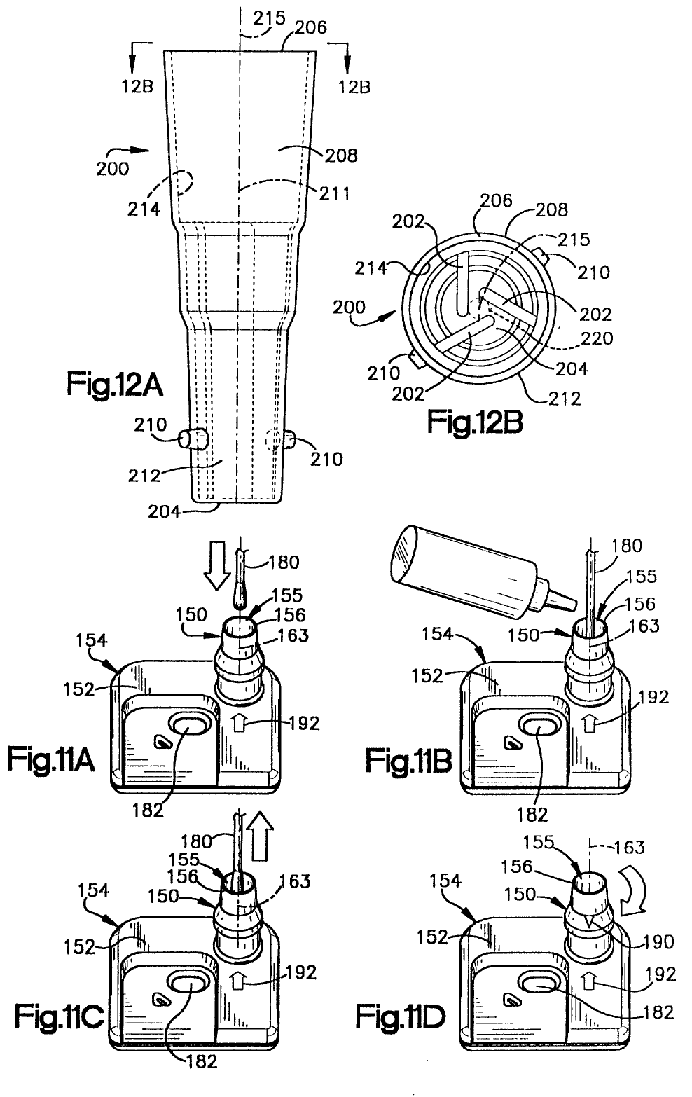

FIGS. 12A and 12B depict one embodiment of a container 200 having internal projections 202 (FIG. 12B). The container 200 is generally cylindrical, with the cross-sectional area of the container 200 increasing in step-wise fashion from the bottom wall 204 of the container 200 to the open top 206. The peripheral wall 208 needn't be flexible in the manner described above with reference to the peripheral walls 48, 86 and 106.

Some or all of the bottom wall 204 is a membrane preferably having a thickness less than ½ the thickness of the peripheral wall 208, more preferably having a thickness less than ¼ the thickness of the peripheral wall 208, and most preferably having a thickness less than 1/10 the thickness of the peripheral wall, but greater than 0.01 mm. The bottom wall 204 is thus constructed as a pierceable membrane like the bottom wall 102 of the container 100 described above. A pair of pins 210, which are like the pins 104 of FIG. 7A, project from the outer surface 212 of the peripheral wall 208. The container 200 is thus constructed for use with a test pack housing like the test pack housing 110.

The projections 202 extend from the peripheral wall 208 of the container 200 into the interior of the container. The projections 202 preferably have a thickness from about 0.2 mm to about 3 mm, more preferably from about 0.5 mm to about 2 mm, and most preferably from about 0.75 mm to about 1.75 mm. Like the peripheral wall 208, the projections 202 may have a uniform or non-uniform thickness. Also, the thickness of the projections 202 may or may not equal the thickness of the peripheral wall 208. Furthermore, the thickness of one projection 202 may or may not equal the thickness of other projections 202.

The projections illustrated in FIGS. 12A and 12B extend inwardly a distance greater than the straight-line distance from the inner surface 214 of the peripheral wall 208 to the longitudinal central axis 215 of the container 200. Furthermore, each of the projections 202 is laterally offset from the axis 215. The projections 202 in the preferred embodiment are integral with both the peripheral wall 208 and the bottom wall 204. The axial length of the projections 202 is preferably at least ¼ the container length, more preferably at least ½ the container length, and most preferably ⅔ the container length.

As shown in phantom view in FIG. 12B, a swab 220 is receivable between the projections 202 in a position centered on the axis 215. During a selected pretreatment time, the operator of the test can rotate the swab 220 in either direction about the axis 215. The operator can also move the swab 220 axially so that the swab 220 contacts the projections 202 both above and below the liquid level. By moving the swab 220 rotatably, axially, or both, the operator exerts compressive, frictional, and other forces on the swab 220 and sample. Specifically, the projections 202 in the preferred embodiment are oriented so as to compress the swab 220 radially therebetween. This causes the swab 220 to undergo a pumping action which expels liquid as the swab 220 compresses and expands upon being rotated about the axis 215 between the projections 202.

Once the desired pretreatment time has passed, the operator of the test can raise the swab 220 so that it remains in contact with the projections 202, but is above the liquid level. The operator can then rotate the swab 220 so that compressive, frictional, and other forces act to force sample and liquid out of the swab and into the liquid below. The operator can also move the swab 220 axially so that the swab 220 goes in and out of contact with the projections 202, or portions of the projections 202, located above the liquid level. Generally the swab 220 is then removed.

### EXAMPLE

A method of manipulating a flexible cup during a selected pretreatment time was compared with a method and device of the present invention.

a) Manipulation of flexible cup.

Five drops of acetic acid and 5 drops of sodium nitrite solution were added to a flexible cup. A swab seeded with Group A streptococcus (20,000 organisms) was then placed in the cup. After 1 minute, the swab was squeezed by pinching the outside of the cup to force liquid from the swab into the solution below. Next, 0.33 ml of the pretreated sample were pipetted onto a chromatographic strip binding assay specific for antigens of Group A streptococcus. After 5 minutes, the optical intensity of the labeled streptococcus antigens was determined. After 10 minutes the optical intensity of the labeled streptococcus antigens was again determined.

b) Method of the present invention.

Five drops of acetic acid and 5 drops of sodium nitrite solution were added to a container of the present invention (the embodiment depicted in FIGS. 12A and 12B). A swab seeded with Group A streptococcus (20,000 organisms) was then placed in the container. After 1 minute, the swab was rotated 5 times with the swab immersed and 5 times with the swab positioned above the liquid level. The contents were then poured from the container into a cup, from which 0.33 ml of the pretreated sample were pipetted onto a chromatographic strip binding assay specific for antigens of Group A streptococcus. After 5 minutes, the optical intensity of the labeled streptococcus antigens was determined. After 10 minutes the optical intensity of the labeled streptococcus antigens was again determined. The results of this comparison of optical intensity are presented in the following table:

| | Manipulation | Method of |
|---|---|---|
| | of Cup | Present Invention |
| 5 min | 9.8 | 11.8 |
| 10 min | 12.8 | 14 |

The present invention encompasses variations of the methods described above. Rather than attach a container of the present invention to a test-device housing before pretreating the sample, a test operator can pretreat the sample in the container and then attach the container to the test-device housing. Also, the operator can move a sample-collecting device (and sample) against projections 202 in the container 200 before adding a liquid reagent, when the sample-collecting device is immersed in any liquid reagents, when the sample-collecting device is above the liquid level of any added liquid reagents, or some combination thereof. Furthermore, an operator can add one or more reagents to a container of the present invention before inserting a sample-collecting device (and sample) into the container. Finally, the invention encompasses reagents added to label the analyte of interest for subsequent detection using a testing device. For a given type of sample and analyte, simple experiments can identify the number and types of movements that optimize sample pretreatment (e.g., release of Group A streptococcus antigens). Thereafter operators can repeat the identified movements during sample pretreatment.

Although the foregoing invention has been described in some detail by way of illustration and example for purposes of clarity of understanding, changes and modifications may be practiced within the scope of the appended claims.

We claim:

1. Apparatus comprising:
a testing device operative to detect and provide an output indicative of an analyte in a test sample; and
a container having an opening configured to receive the test sample;
said testing device including a support structure configured to engage and support said container in a predetermined pretreatment orientation, and to engage and support said container for movement relative to said support structure from said pretreatment orientation to a predetermined testing orientation;
said container and said testing device being configured to block said testing device from detecting the analyte in the sample when said container is in said pretreatment orientation, and to enable said testing device to detect the analyte in the sample in response to said movement of said container relative to said support structure from said pretreatment orientation to said testing orientation.

2. Apparatus as defined in claim 1 wherein said container is configured to contain the test sample at a location remote from said testing device and to interlock with said testing device upon being moved into engagement with said support structure in said pretreatment orientation.

3. Apparatus as defined in claim 1 wherein said container comprises a cup-shaped structure defining a compartment with an open upper end for receiving the sample, said container and said testing device being configured such that said open upper end of said compartment remains open to provide continuous open access to said compartment throughout said movement of said container from said pretreatment orientation to said testing orientation.

4. Apparatus as defined in claim 1 wherein said support structure defines an opening in which said container is received in said pretreatment orientation, said movement of said container consisting of movement within said opening relative to said support structure.

5. Apparatus as defined in claim 4 wherein said container comprises an elongated cup-shaped structure with a longitudinal axis, said movement of said container comprising rotation of said container about said axis relative to said support structure.

6. Apparatus as defined in claim 5 wherein said movement of said container further comprises shifting of said container along said axis.

7. Apparatus as defined in claim 1 wherein said container has an interior compartment for containing the sample, said container and said testing device being configured to initiate a flow of the sample from said compartment to said testing device upon said movement of said container from said pretreatment orientation to said testing orientation.

8. Apparatus as defined in claim 7 wherein said compartment is defined in part by a semi-permeable membrane portion of said container which moves into fluid flow contact with a corresponding membrane portion of said testing device upon said movement of said container from said pretreatment orientation to said testing orientation.

9. Apparatus as defined in claim 7 wherein said testing device and said container together define a valve which opens upon said movement of said container from said pretreatment orientation to said testing orientation.

10. Apparatus as defined in claim 7 wherein said testing device is configured to initiate said flow by rupturing said container upon said movement of said container from said pretreatment orientation to said testing orientation.

11. Apparatus as defined in claim 10 wherein said container comprises a shear pin, said testing device defining an aperture into which said shear pin extends when said container is in said pretreatment orientation.

12. Apparatus as defined in claim 10 wherein said testing device is configured to initiate said flow by puncturing said container upon said movement of said container from said pretreatment orientation to said testing orientation.

13. Apparatus comprising:
a container defining a chamber having sufficient volume to contain a sample including an analyte, a reagent added to pretreat the sample, and a portion of a sample-collecting device inserted into the chamber; and
projections extending from the interior surface of the container into said chamber, said projections being configured to exert a force on the sample-collecting device so as to remove the sample from the sample collecting device upon movement of the sample-collecting device against said projections.

14. Apparatus as defined in claim 13 wherein said projections are planar.

15. Apparatus as defined claim 13 wherein said container is configured to be mated to and placed in fluid communication with a testing device for detecting the analyte in the sample.

16. Apparatus as defined in claim 13 wherein said projections extend inwardly of said chamber a distance greater than the straight-line distance from said inner surface to the center of said chamber.

17. Apparatus as defined in claim 13 wherein said projections are integral with a bottom wall and a peripheral wall of said container.

18. Apparatus as defined in claim 13 wherein said projections have a length that is at least ½ the container length.
